(19) United States
(12) Patent Application Publication
(10) Pub. No.: US 2002/0076033 A1
(43) Pub. Date: Jun. 20, 2002

(54) Intelligent telephone ringer control and method

(75) Inventors: Beljeet Singh Baweja, Austin, TX (US); Kulvir Singh Bhogal, Fort Worth, TX (US); Nizamudeen Ishmael JR., Austin, TX (US); Mandeep Singh Sidhu, Austin, TX (US)

Correspondence Address: Loren G. Helmreich, Intellectual Property Law Dept., IBM Corporation, 11400 Burnet Road, Zip 4054, Austin, TX, 78758, US

(73) Assignee: International Business Machines Corporation

(21) Appl. No.: 09/737,457

(22) Filed: Dec. 14, 2000

(51) Int. Cl. H04M 1/00; H04M 3/00

(52) U.S. Cl. 379/373.01

(57) ABSTRACT

An intelligent telephone notification system and method are disclosed wherein the notification means is programmable to be responsive to ambient conditions. For instance, the ringer tone and volume may be selected from a menu related to anticipated ambient conditions. Thus, the ringer volume may be set to automatically adjust in volume according to the ambient noise level. In one embodiment, the ringer volume may be set to be a selected number of decibels above the ambient noise. The ambient conditions such as ambient noise may preferably be sampled using the built-in telephone microphone and connections thereto to avoid the cost of additional sensors and sensor interfacing. The ambient conditions may be sampled in response to an incoming message such as an incoming telephone call or the ambient conditions may be sampled at regular intervals.

### BACKGROUND OF THE INVENTION

1. Field of the Invention

The present invention relates generally to telephones such is mobile telephones and, more particularly, to apparatus and methods for controlling the ringer or other notifying means for signals such as incoming phone calls.

2. Description of the Background

One of the problems with mobile phones is that the ringer can sound excessively loud when ambient noise conditions are very soil such as in a library or other relatively quiet location. The resulting noise may be disturbing to persons in the immediate area and excessively louder than required to notify the operator that a call is incoming. On the other hand, when ambient noise conditions are loud, then the same ringer volume may not even be heard.

For those telephones, pagers, or other message transmission units with vibration or scratching notifiers as well as rings, there may likewise be certain ambient conditions under which the vibration notifiers may not be easily perceived and a ringer would be better if the device provides that option. Consequently, it would be desirable to have a phone or messenger device that automatically responds with an appropriate means of notification based on ambient conditions Those skilled in the art have long sought and will appreciate the present invention which provides solutions to these and other problems.

### SUMMARY OF THE INVENTION

The present invention was designed to provide an improved notification system for an electronic communication device such as a telephone or mobile telephone.

Another object of the present invention is to provide an improved mobile telephone.

These and other objects, features, and advantages of the present invention will become apparent from the drawings, the descriptions given herein, and the appended claims.

Therefore, the present invention may provide for an intelligent telephone notification method comprising steps such as, for example, sampling ambient conditions, detecting an event requiring notification, and automatically providing notification of the event responsively to the sampled ambient conditions. An event may comprise an incoming message such as all incoming phone call. The step of sampling ambient conditions may comprise sampling ambient noise levels. Other steps may include selecting a noise level for a ringer responsive to a sampled ambient noise or providing a menu for selecting a response based on the ambient conditions. In a preferred embodiment the telephone microphone is used for sampling the ambient conditions so as to avoid the need for additional sensors and connections to the sensors. The ambient conditions may be sampled in response to the step of detecting an event requiring notification or may be sampled at selected time intervals or some combination of sampling and averaging may be used. In one embodiment, steps may include sampling a level of ambient noise, and producing a ring having a volume greater than the level of ambient noise.

Therefore an intelligent telephone notification system is provided that may comprise one or more of the following elements such as a telephone, a microphone for the telephone, a ringer for the telephone, a sampling circuit for sampling ambient noise using the microphone, and a control for varying a volume of the ringer responsively to the ambient noise. Other elements may include a menu to permit an operator to select ringer characteristics for anticipated ambient noise conditions. The menu may allow selection of ringer characteristics such as a volume of the ringer or a tone of the ringer or other features thereof. The telephone preferably includes a detector for detecting an incoming call and may include a control for initiating operation of the sampling circuit to sample ambient noise responsively to the detector detecting an incoming call.

### BRIEF DESCRIPTION OF THE DRAWINGS

FIG. 1 is a schematical representation of a diagram for method for controlling a notification device such as a telephone ringer responsively with respect to ambient conditions; and

F1G. 2 is a schematical representation, in block diagram format, of a system in accord with the present invention.

While the present invention will be described in connection with presently preferred embodiments, it will be understood that it is not intended to limit the invention to those embodiments. On the contrary, it is intended to cover all alternatives, modifications, and equivalents included within the spirit of the invention.

### DETAILED DESCRIPTION OF THE PREFERRED EMBODIMENTS

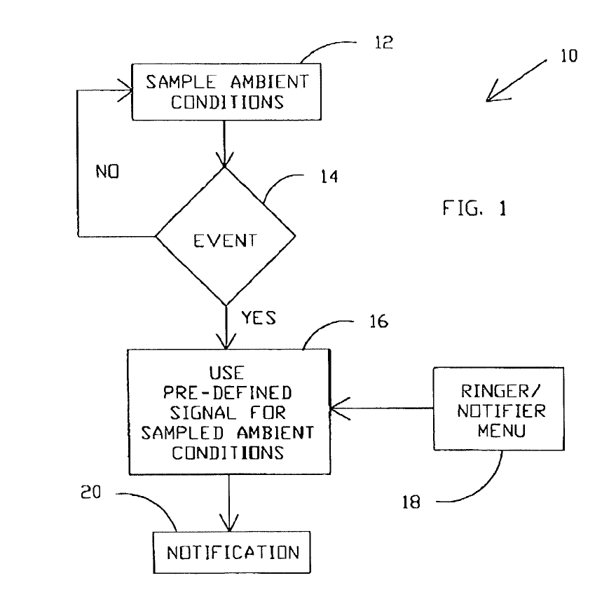

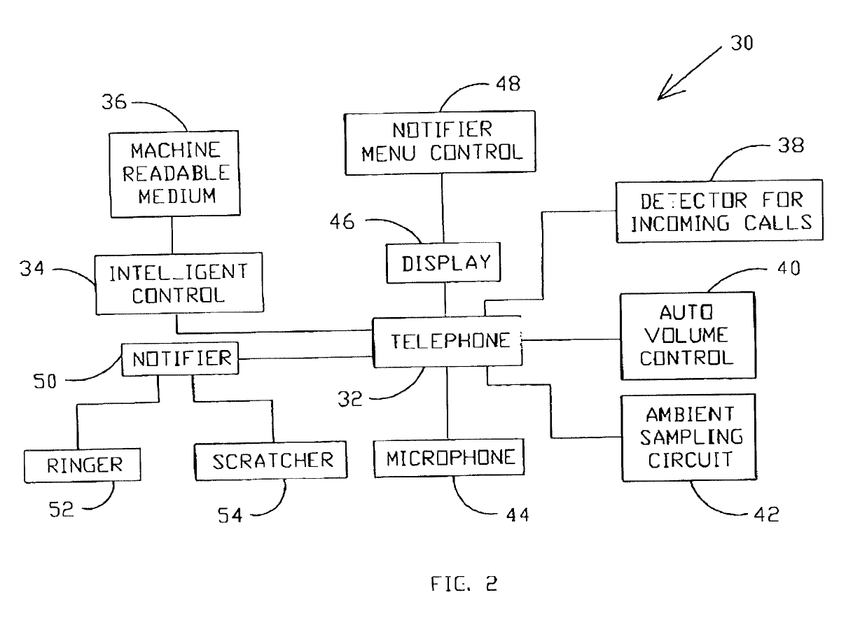

Referring now to FIG. 1, there is shown a diagram for a notification control system 10 which is suitable for use with a communication device such as a mobile telephone in accord with the present invention. The present invention provides that the notification provided such as for an incoming telephone call may be adjusted according to ambient conditions such as ambient noise levels.

A sampling means 12 is preferably provided in system 10 for sampling or measuring the ambient conditions. In one presently preferred embodiment, sampling means 12 may include the microphone normally found in the telephone along with the interconnections to the microphone. In this way, the sensing device and must if not all of the related wiring costs are eliminated. Preferably, the present invention can be largely implemented by software control of presently existing telephone electronics. Thus, software control will permit turning on the telephone microphone to sample ambient conditions when desired.

The sampling may occur prior to or after event 14 occurs, such as an incoming telephone call or message. When event 14 occurs, a sample of the ambient conditions may be taken in response to the event as indicated at 12. Alternatively, sampling 12 may occur in the background at regular intervals and when event 14 occurs, the latest sample or average of samples will be used to set die notification signal as indicated at 16, such as telephone ringer volume and/or tone. As yet another alternative, some combination of background sampling and sampling in response to event 14 may be used for averaging purposes or the like.

Preferably, element 16 of the invention may provide for a predefined response to ambient conditions. For instance, menu 18 or switches or other selection means could be used to program ringer characteristics depending on anticipated ambient conditions such as quiet ambience or loud ambience. As one example, the ringer might be set a predefined level for each specific described range of ambient background. As another example, the ringer may be configured to have a volume that is a fixed number of decibels louder than the sampled ambient noise level so as to always be heard but not be excessively loud. FIG. 2 discloses system 30 in accord with a preferred embodiment of the present invention. System 30 may preferably be used with a receiving device such as, for example, telephone 32 or any other type of receiving device. Intelligent control 34 may be used for overall control of the function of the system in accord with the present invention although various separate hardware/software modules may be used. Intelligent control may preferably include machine readable medium 36 which may include any type of memory that is suitable for the application such as removable or permanent memory and may include but is not limited to semiconductor memory, disk storage either removable or permanent, or other types of memory. Machine readable medium 36 may also reside outside the system such as used for programming semiconductor memory that is finally placed inside a telephone or other sender/receiver such as telephone 32.

As discussed hereinbefore, detector 38 may be used to initiate system operation by detecting an incoming signal such as, for instance, an incoming phone call. Automatic volume control 40 may be used to control a volume or other aspect of notifier 50 which may include notification devices such as ringer 52, scratcher 54, or any other type of notifier. Ambient sampling circuit 42 is used for producing a signal used to control automatic volume control and may sample ambient signals such as sound level or other signals. In a preferred embodiment, microphone 44 is used for sampling purposes such as sampling ambient noise levels. Ambient sampling circuit 42 may be controlled by intelligent control 34 and/or machine readable medium 36, or other means to sample ambient conditions at the desired time or times. The output from ambient sampling circuit may be stored in machine readable medium 36, or other memory as desired, for use at the desired time. Alternatively, the output form ambient sampling circuit 42 may utilized real time without need of storage for future use as discussed hereinbefore.

In a preferred embodiment, an operator may select a desired notification by means, such as for instance only, display 46 which may be used to display notifier menu from which the desired response may be conveniently selected by the user. Alternatively, keystroke control from telephone 32 may be used without a display.

Therefore, based on prior programming as indicated at 18, and in response to an event such as an incoming massage as indicated at 14, the appropriate notification is given as indicated at 20. Depending on the type of telephone 32, the means for notification may include not only ringer 52 but also a vibrator, scratcher 54, or the like. Under certain ambient conditions, the vibrator may be selected as the notification means 20 and/or notifier 50, and under other ambient conditions, ringer 52 could be selected as notification means, all of which could be programmed as indicated at 18 such as by using display 46 and notifier menu control 48.

It will be seen that various changes and alternatives may be used that are contained within the spirit of the invention. For instance, although preferably the microphone is used to detect ambient conditions, other sensors may also be used if desired. For instance, under conditions of user movement, a vibrational notification means might not be so apparent such as while the user is jogging. Thus, an accelerometer or other sensor might be used in conjunction with the microphone to determine whether to use a vibrational notification means or a ringer or both.

Therefore, the foregoing disclosure and description of the invention is illustrative and explanatory thereof, and it will be appreciated by those skilled in the art, that various changes in the size, shape and materials, the use of mechanical and electrical equivalents, as well as in the details of the illustrated construction or combinations of features of the various elements may be made without departing from the spirit of the invention.

What is claimed is:

1. An intelligent telephone notification method, comprising:
sampling ambient conditions;
detecting an event requiring notification; and
automatically providing notification of said event responsively to said sampled ambient conditions.

2. The intelligent telephone notification system of claim 1, wherein said event comprises:
an incoming phone call.

3. The intelligent telephone notification system of claim 1, further comprises: sampling ambient noise levels.

4. The intelligent telephone notification system of claim 3, further comprising:
selecting a volume level for a ringer responsive to a sampled ambient noise.

5. The intelligent telephone notification system of claim 1, further comprising providing a menu for selecting a response based on said ambient conditions.

6. The intelligent telephone notification system of claim 1, further comprising:
utilizing a telephone microphone for sampling said ambient conditions.

7. The intelligent telephone notification system of claim 1, further comprising:
sampling said ambient conditions in response to said step of detecting an event requiring notification.

8. The intelligent telephone notification system of claim 1, further comprising:
sampling ambient conditions at selected time intervals.

9. The intelligent telephone notification system of claim 1, further comprising:
sampling a level of ambient noise, and
producing a ring having a volume greater than said level of ambient noise.

10. A method for intelligent notification comprising:
detecting an event requiring notification;
electronically measuring an ambient condition; and
providing notification of said event in a manner that is responsive to said electronically measured ambient conditions.

11. The method of claim 10, further comprising:
detecting an incoming phone call.

12. The method of claim 11, further comprising:
electronically measuring an ambient noise level in response to said incoming phone call.

13. The method of claim 11, further comprising:
electronically measuring an ambient noise level at selected intervals prior to said incoming phone call.

14. The method claim 11, further comprising:
providing a ring that has a volume louder than said ambient noise level by a selectable amount.

15. The method of claim 10, further comprising:
utilizing a predefined notification signal for ambient conditions.

16. An intelligent telephone notification system said intelligent telephone notification system comprising:
a telephone;
a microphone for said telephone,
a ringer for said telephone;
a sampling circuit for sampling ambient noise using said microphone; and
a control for varying a volume of said ringer responsively to said ambient noise.

17. The intelligent telephone notification system of claim 16, further comprising:
a menu to permit an operator to select ringer characteristics for anticipated ambient noise conditions.

18. The intelligent telephone notification system of claim 17, further comprising:
at least one of said ringer characteristics being a volume of said ringer.

19. The intelligent telephone notification system of claim 17, further comprising:
at least one of said ringer characteristics being a tone of said ringer.

20. The intelligent telephone notification system of claim 16, further comprising,
a detector for detecting an incoming call.

21. The intelligent telephone notification system of claim 20, further comprising:
a control for initiating operation of said sampling circuit to sample ambient noise responsively to said detector detecting an incoming call 26. A program storage device readable by a machine, said program storage device embodying a program of instructions executable by the machine to perform a method for intelligent notification, said method comprising:
detecting an event requiring notification;
electronically measuring an ambient condition; and
providing notification of said event in a manner that is responsive to said electronically measured ambient conditions.

22. The program storage device or claim 22, said method further comprising:
detecting an incoming phone call.

23. The program storage device of claim 23, said method further comprising:
electronically measuring an ambient noise level in response to said incoming phone call.

24. The program storage device of claim 22, said method further comprising:
electronically measuring an ambient noise level at selected intervals prior to said incoming phone call.

25. The program storage device of claim 22, said method further comprising:
providing a ring that has a volume louder than said ambient noise level by a selectable amount.

26. The program storage device of claim 21, said method further comprising,
utilizing a predefined notification signal for ambient conditions.
